(19) United States
(12) Patent Application Publication
(10) Pub. No.: US 2019/0233135 A1
(43) Pub. Date: Aug. 1, 2019

(54) METHOD AND SYSTEM FOR DELIVERING GOODS USING AN UNMANNED AERIAL VEHICLE

(71) Applicant: Walmart Apollo, LLC, Bentonville, AR (US)

(72) Inventors: Robert CANTRELL, Herndon, VA (US); Todd MATTINGLY, Bentonville, AR (US); John J. O'BRIEN, Farmington, AR (US); David TOVEY, Rogers, AR (US); Donald R. HIGH, Noel, MO (US); Kurt W. BESSEL, Mexico, NY (US)

(73) Assignee: Walmart Apollo, LLC, Bentonville, AR (US)

(21) Appl. No.: 16/257,278

(22) Filed: Jan. 25, 2019

Related U.S. Application Data
(60) Provisional application No. 62/624,691, filed on Jan. 31, 2018.

(51) Int. Cl. B64F 1/32; B64F 1/00

(52) U.S. Cl. CPC B64F 1/32; A47G 29/141; B64F 1/005

(57) ABSTRACT

A system and a method for protecting a user from potentially falling unmanned aerial vehicle (UAV) or package or both are described herein. The system includes a base structure; and a roof structure attached to and extending from the base structure. The base structure is configured to support the roof structure. The roof structure is configured to support a weight of the UAV and package. The roof structure is configured to shield or protect a user from potentially falling UAV or package or both when the user is under the roof structure.

### CROSS-REFERENCE TO RELATED APPLICATIONS

The present patent application claims priority benefit to U.S. Provisional Patent Application No. 62/624,691 filed on Jan. 31, 2018, the entire content of which is incorporated herein by reference.

### BACKGROUND

### 1. Technical Field

The present disclosure relates generally to unmanned aerial vehicles transport and more specifically to a method and system for delivering goods using an unmanned aerial vehicle (UAV).

### 2. Introduction

Unmanned Aerial Vehicles (UAVs), commonly known as drones, are becoming ubiquitous. UAVs are increasingly used in aerial imagery and photography, for surveillance, commercial application, real-estate applications, scientific applications, equipment inspections, agricultural applications, military applications, and recreational applications. UAVs are also contemplated as transport vehicles for delivering goods such as packages. An UAV is an aircraft that is piloted without a human pilot aboard the aircraft. The UAV can be operated using a remote control device by a human operator. The UAV can also be operated autonomously by an onboard programmed or programmable computer(s) programmed to execute a specific series of commands or instructions to control the UAV.

A safety concern arises when operating UAVs above people known as “Operation Over People” (OOP). In an OOP, a UAV or its package may fall on a person accidently and may cause injury. To prevent this type of accidents, systems are needed to shield people from mishaps/accidents or to prevent the UAV from performing an OOP.

Therefore, there is a need for a novel system and method for transporting or moving goods (e.g., a package) with an UAV while insuring that people are protected from potential accidents that could result in the UAV and/or the package falling on and injuring a person.

### SUMMARY

An aspect of the present disclosure is to provide a system for protecting a user from potentially falling unmanned aerial vehicle (UAV) or package or both. The system includes a base structure; and a roof structure attached to and extending from the base structure. The base structure is configured to support the roof structure. The roof structure is configured to support a weight of the UAV and package. The roof structure is configured to shield or protect a user from potentially falling UAV or package or both when the user is under the roof structure.

Another aspect of the present disclosure is to provide a system for protecting a user from potentially falling unmanned aerial vehicle (UAV) or package or both. The system includes a collision avoidance system on the UAV, the collision avoidance system being configured to communicate with sensors provided on the UAV and configured and arranged to detect people within a certain distance range so as to enable the UAV to perform avoidance manoeuvers to prevent collision with people.

Another aspect of the present disclosure is to provide a method for protecting a user from potentially falling unmanned aerial vehicle (UAV) or package or both. The method includes deploying a roof structure from a base structure so that the roof structure is attached to and extending from the base structure; landing a UAV carrying a package on the roof structure; and supporting a weight of the UAV and package by the roof structure attached to the base structure. The roof structure is configured to shield or protect a user from potentially falling UAV or package or both when the user is under the roof structure.

Additional features and benefits of the disclosure will be set forth in the description which follows, and in part will be obvious from the description, or can be learned by practice of the herein disclosed principles. The features and benefits of the disclosure can be realized and obtained by means of the instruments and combinations particularly pointed out in the appended claims. These and other features of the disclosure will become more fully apparent from the following description and appended claims, or can be learned by the practice of the principles set forth herein. It is to be expressly understood, however, that the drawings are for the purpose of illustration and description only and are not intended as a definition of the limits of the disclosure.

### BRIEF DESCRIPTION OF THE DRAWINGS

FIG. 1 shows a system for retrieving a package delivered by a UAV and protecting a recipient of the package from potentially falling UAV and/or package, according to an embodiment of the present disclosure;

FIG. 2 depicts schematically a system for protecting a user from potential UAV collision, according to an embodiment of the present disclosure;

FIG. 3 depicts schematically a system for protecting a user from potential UAV collision, according to another embodiment of the present disclosure;

FIG. 4 depicts schematically a system for protecting a user from potential UAV collision, according to yet another embodiment of the present disclosure;

FIG. 5 depicts schematically a system for protecting a user from potential UAV collision, according to another embodiment of the present disclosure; and

FIG. 6 depicts schematically a system for protecting a user from potential UAV collision, according to another embodiment of the present disclosure

### DETAILED DESCRIPTION

In the following paragraphs, several solutions are described that involve either providing a roof or structure to shield people from potentially falling UAVs or falling packages from the UAVs, or to obviate the need for Operations Over People (OOPs). In an embodiment, a roof or structure to shield people from potentially falling UAVs and/or packages can be used for example in designated areas where a recipient of the package can safely retrieve the package without being in danger of being hit by a falling package and/or a falling UAV. The designated area can include a “kiosk” where the recipient of the package carried by a UAV uses the kiosk to retrieve the package.

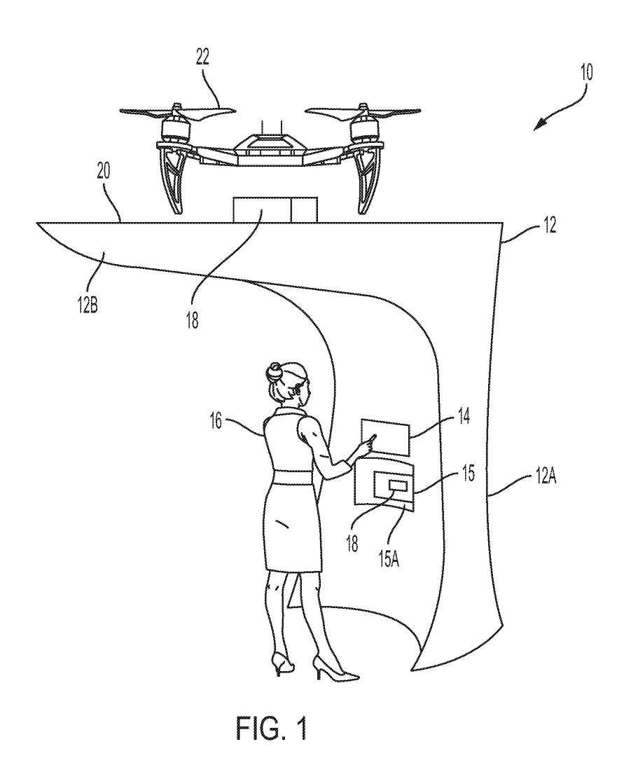

FIG. 1 shows a system for retrieving a package delivered by a UAV and protecting a recipient of the package from potentially falling UAV and/or package, according to an embodiment of the present disclosure. As shown in FIG. 1, the system 10 includes a building structure 12. The building structure 12 has base structure 12A (e.g., kiosk) that is provided with a computer system 14 for logging credentials of a user 16. The base structure 12A of the building structure 12 is also provided with a package retrieval system 15 having an opening 15A for retrieving or sending a package 18. The term “package retrieval system” is used herein to mean that a system can take a package from the user or provide a package to the user. The building structure 12 also has a roof structure 12B supported by the base structure 12A and extending substantially horizontally to shield or protect the user 16 when under the roof structure 12B. Although, a computer system 14 is depicted herein as being used by the user 16 to enter credential to retrieve or pick-up a package, the computer system 14 may not be provided on the base structure 14. Instead, the user may employ a handheld device such as mobile phone, a tablet, a laptop computer or the like to communicate the user's credentials wirelessly, for example through the internet to a central computer which can then provide authorization to the user to retrieve or drop-off the package.

The roof structure 12B of the building structure 12 is configured and arranged to also provide a landing/take-off platform 20 for an UAV 22. In this way, the UAV 22 carrying the package 18 can land/take-off safely on the platform 20 of the roof structure 12B without imperiling the user 16. For example, the package 18 carried by the UAV 22 can be released into a transport system (not shown) and delivered to the user 16, after verification of user's credentials, through the opening 15A of the package retrieval system 15. In an embodiment, the package 18 can be for example delivered to the user 16 using a gravity slide or chute, or using a conveyor or an Automatic Guided Vehicle (AGV) system. As it can be appreciated various systems can be used to transport the package 18 from the platform 20 where the UAV 22 lands or takes-off and the package 18 is deposited to the opening 15A of the package retrieval system 15 that is located within reach of the user 16, thus enabling the user to safely retrieve or deposit the package 18.

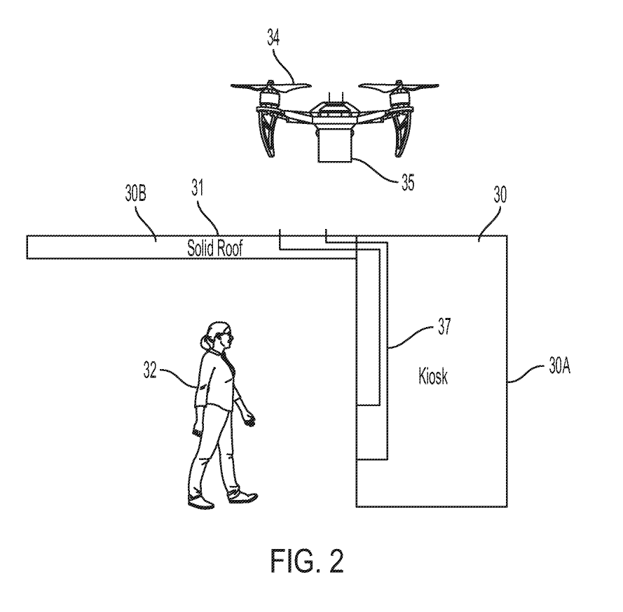

In an embodiment, the roof structure 12B can have various configurations. FIG. 2 depicts schematically a system for protecting a user from potential UAV collision, according to an embodiment of the present disclosure. The system includes a building structure 30 having a base structure 30A (for example a kiosk) and a roof structure 30B. The roof structure 30B extends from the base structure 30A to protect a user 32 when under the roof structure 30B. The roof structure 30B is supported by the base structure 30A. The roof structure 30B is configured to protect the user against UAV 34 or a package 35 carried by the UAV 35 potentially falling on the user 32. In an embodiment, the roof structure 30B is solid in which case the roof structure 30B is further configured to protect the user 32 from environmental elements such as rain, hail and sunlight.

In an embodiment, the roof structure 30B can be further configured (i.e., provided large enough and strong enough) to support a weight of the UAV 34 and package 35 landing on top of the roof structure 30B. For example, the roof structure 30B can include a platform 31 on top of the roof structure 30B to provide a landing/take-off zone for the UAV 34. The UAV 34 can land on the platform 31 of the roof structure 30B securely as an emergency stop without interfering with regular operations or as a planned stop to deliver the package 35 to the user via a delivery mechanism or system provided on the base structure 30A (e.g., kiosk), as described in the above paragraphs.

In an embodiment, the platform 31 on the roof structure 30B can provide a large visual target to be “seen” by the UAV 34 during flight. In an embodiment, the base structure (e.g., kiosk) can be provided large enough to be used as not only a delivery area but also as pick up area wherein a package can be deposited at the base structure 30A and the package carried using an appropriate transport system 37, such as a conveyor or an AGV system, to the platform 31 where the UAV 34 can pick up the package 35.

In an embodiment, the roof structure 30B can be an already existing roof structure such as the roof of a building (an office building, an apartment building, a tower, etc.). In which case, the base structure 30A can be attached to the roof structure 30B. For example, the base structure 30A can be part of a wall supporting the roof structure 30B. The base structure 30A is provided at a base of the building (office building, apartment building, a tower, etc.). The transport system 37, such as a slide or chute, conveyor or an AGV system, can be installed to transport the package 35 between the roof structure 30B to the base structure (e.g., kiosk) 30A. The transport system 37 can be configured to transport the package 35 from the base structure 30A to the roof structure 30B for delivering from the user 32 to the UAV 34 or vice versa from the roof structure 30B to the base structure 30A for delivering from the UAV 34 to the user 32.

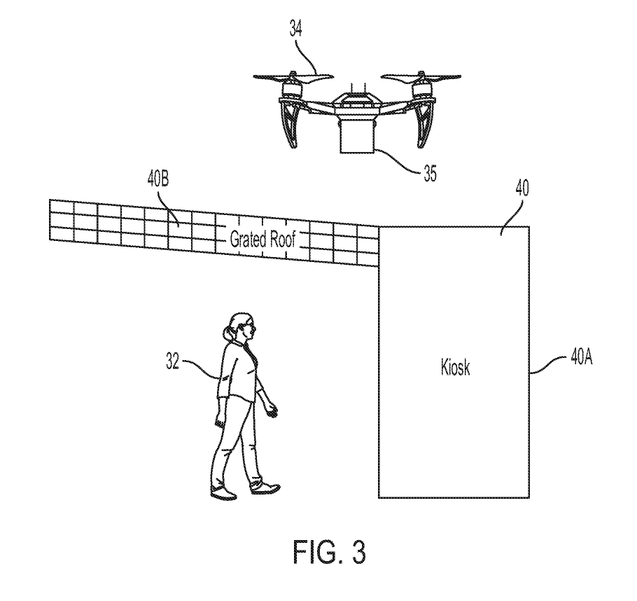

FIG. 3 depicts schematically a system for protecting a user from potential UAV collision, according to another embodiment of the present disclosure. The system includes a building structure 40 having a base structure 40A (for example a kiosk) and a roof structure 40B. The system shown in FIG. 3 is similar in many aspects to the system shown in FIG. 2. Therefore, similar features will not be further described in the following paragraph. The embodiment shown in FIG. 3 contains many of the aspects described above with respect to FIG. 2. However, in the system shown in FIG. 3, the roof structure 40B instead of including a solid structure as in the roof structure 30B, the roof structure 40B includes a net or grill. The roof structure 40B including the grill or net can be configured to protect the user 32 against potentially falling UAV 34. However, in this case, the net or grill of the roof structure 40B may not provide protection against environmental elements such as rain, sunlight, etc.

In an embodiment, the roof structure 40B may include a perforated portion and a solid portion. The perforated portion may be perforated in two layers to facilitate flow of air. The solid portion may be provided to protect the user 32 at the actual delivery zone from environmental element such as rain. The perforated portion can be attached to the solid portion using various means including fasteners, linkages, soldering, glue, etc. The solid portion may provide an area for landing/take-off of the UAV. In an embodiment, the perforated portion can be configured to have perforations or openings with smaller dimensions than a smallest dimension of the package 35 to retain the package 35 and prevent the package 35 from falling through an opening of the perforated portion.

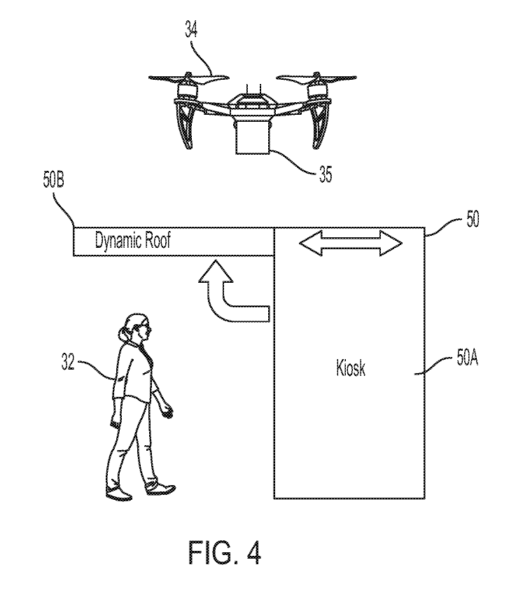

FIG. 4 depicts schematically a system for protecting a user from potential UAV collision, according to yet another embodiment of the present disclosure. The system includes a building structure 50 having a base structure 50A (for example a kiosk) and a roof structure 50B. The system shown in FIG. 4 is similar in many aspects to the system shown in FIGS. 2 and 3. Therefore, similar features will not be further described in the following paragraph. The embodiment shown in FIG. 4 contains many of the aspects described above with respect to FIGS. 2 and 3. However, in the system shown in FIG. 4, the roof structure 50B instead of including a solid fixed structure as in the roof structure 30B, the roof structure 50B is a deployable structure configured to deploy upon sensing an eminent arrival of the UAV 34. In an embodiment, the roof structure 50B can include a relatively small solid roof portion that is configured or sized to protect against environmental elements such as rain and sunlight and include a net or canvas portion that folds out upon UAV 34 arrival to cover a larger landing area, temporarily. As depicted by the large arrows in FIG. 4, in an embodiment, the roof structure 50B may include at least a portion that can be deployed by pivoting using a hinge system or deployed by projecting or sliding from the base structure 50A. In an embodiment, the net or canvas portion can also be configured to deploy by extending, projection or sliding out from the relatively small solid roof portion of the roof structure 50B or from the base structure (e.g., kiosk) 50A. For example, the deployable portion can include a perforated portion. For example, by providing at least a portion that is deployable by rotation or by projection, the package 35 can be delivered on top of the roof structure 50B using the UAV 34 while protecting the user 32 during the delivery of the package 35 from the package 35 and/or the UAV potential falling on the user 32.

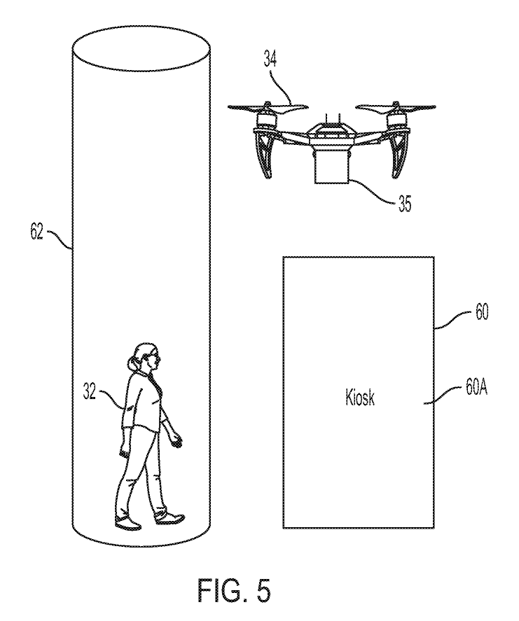

FIG. 5 depicts schematically a system for protecting a user from potential UAV collision, according to another embodiment of the present disclosure. In this embodiment, a roof structure may not be provided to protect the user 32. Instead, a walkway up to the base structure (e.g., kiosk) 60A of the building structure 60 can be geo-fenced so that the UAV 34 does not go over that pathway. For example, the walkway can be geo-fenced at the Differential Global Positioning System (DGPS) accuracy level. In an embodiment, a collision avoidance system can be provided on the UAV. The collision avoidance system is in communication with sensors configured and arranged to detect people within a certain distance range so as to enable the UAV to perform avoidance manoeuvers to prevent collision with people. The distance range can be selected depending on the speed of the UAV. For example, the faster the UAV, the greater the distance range so as to provide more time for the UAV to perform avoidance maneuvers. In another embodiment, the collision avoidance system can rely on geolocation using GPS. For example, the base structure can be geo-fenced to protected user around the geo-fenced area of the base structure. For example, DGPS accuracy level or localized grids can be used for geo-fencing. The term localized grid means that the area is precisely mapped as a localized grid by which people are detected, creating data points where the data point corresponding to the UAV 34 can never cross. Altitude of the UAV 34 and winds may also be taken into account. Other methods that can be used for people avoidance by the UAV 34 include non-localization grid methods where people are detected optically, via heat signature, through detected movement (using for example lasers), or other techniques. For example, the UAV may use a detection system similar to Light Detection and Ranging (LIDAR) or the like to locate moving persons and/or objects, thus enabling the UAV to avoid flying above or in the vicinity of the persons and/or objects.

In an embodiment, the UAV 34 can be configured to deliver the package 35 only when the delivery area near the building structure 60 is clear of people. In an embodiment, the localization grid can be defined as ground level X and Y axis with perhaps a three or a four-point system, or more points if desired. The UAV 34 can be configured to use its onboard sensors to determine if an object within the grid is a person or object. In an embodiment, the UAV 34 can be configured to detect people using optics, lasers, heat signature, movement, etc. The UAV 34 can be configured or programmed to never fly over a person or persons when the UAV 34 detects the person or persons for safety reasons. A virtual cylinder 62 can be defined around the person (e.g. user 32) and the UAV 34 can be programmed to not fly over the virtual cylinder 62. Instead, the UAV 34 can be programmed to fly around the cylinder 62. The virtual cylinder 62 defines the space occupied by the user/person 32 at any point in time. The virtual cylinder 62 moves with the user 32. Although a virtual cylinder 62 is used to define a space occupied at any time by a person/user 32, any other shape can also be user to define the space occupied by the person/user, such as a polyhedron or prism. In an embodiment, the onboard sensors provided on the UAV 34 can be optical detectors that detect objects based on shape (shape recognition), heat detectors, or movement detectors.

In an embodiment, instead of or in addition to the above protective structures, an inflatable bladder can be used as a protection at the moment a crash becomes imminent, as indicated by an emergency beacon from the UAV. The bladder can inflate rapidly, for example, using a chemical reaction similar to an airbag to protect people from the impact from the UAV. In an embodiment, in the case of using a deployable structure such as the system shown in FIG. 4 where the roof structure 50B is a deployable structure configured to deploy upon sensing an eminent arrival of the UAV, an umbrella style mechanism that extends out from all sides of the base structure can be used. The deployable structure may include fabric or canvas which can be sufficiently strong and weather resistant and can be used as the umbrella mechanism.

In an embodiment, instead of using a roof structure and/or base structure, a dynamic barrier can be employed to keep people away from the landing and/or takeoff site of the UAV. In an embodiment, an established approach and departure corridor, such as is used in commercial airspace, may help in ensuring that the UAV is not over humans. In an embodiment, pickup windows can be installed and oriented in such a way that people are not interacting with a tower, for example underneath an operating tower. For example, the pickup window can be placed on the east side (approaching tower on 90° angle radial) and the UAV approach path may be on the 135° angle radial and the departure path may be on the 45° angle radial. This feature may be used alone or in combination with the above described building structure and/or roof structure (permanent or deployable).

In an embodiment, human warnings (such as sounds and lights, etc.) may also be provided to let users know that a UAV is approaching. This feature may be used in addition to the above described protection configurations and systems. The warning may be a voice liability warning, disguised as advertising “Attention, a Wal-drone is inbound with someone's order, placed thirteen minutes ago, and ready for pickup. Please remain clear of the marked area on the pavement.”

In addition to providing protection to people, impact resistant materials can also be used on the UAV to protect the UAV itself. Furthermore, in an embodiment, relatively small walls can be provided along the perimeter of the landing/takeoff surface (e.g., roof) to prevent the UAV from falling. This feature can be useful in windy environments. In an embodiment, a side where the UAV lands can be made concave (like a bowl) to contain any liquid spills. In an embodiment, gutters can be used to guide liquids away from the roof to a safe containment location. The gutters can be used for rain, snow, leaky UAVs (battery, hydraulic fluid), or leaking damaged products.

In an embodiment, in order to keep the UAV attached to the roof structure or the landing zone, a suction or an attaching device can be provided to keep the UAV stationary. The suction or attaching device may include a locking clamp/foot device to “tie-down” the UAV. For example, the UAV may be provided with “L-shaped” features on its feet, which can be held in place by hooks provided on the landing zone. The hooks can for example rotate into place after insertion of the L-shaped features to clamp and lock-in the feet in place. The UAV may be locked or attached to the roof structure using the attaching device during package delivery or pickup, for example, when there is excessive wind.

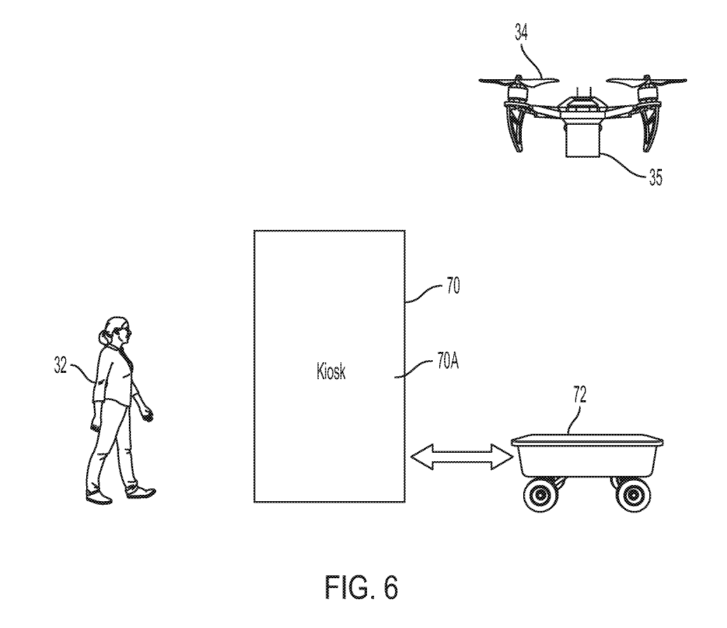

FIG. 6 depicts schematically a system for protecting a user from potential UAV collision, according to another embodiment of the present disclosure. In this embodiment, a roof structure may not be provided to protect the user 32. In this case, a vehicle receptor 72 can be provided on the ground away from user 32 where the UAV 34 can drop the package 35 on the vehicle receptor 72. In this way, package delivery takes place away from the base structure (e.g., kiosk) 70A of building structure 70 where the user 32 collects the package 35. For example, after the UAV 34 drops or releases the package on the vehicle receptor 72. The vehicle receptor 72 can be programmed to transport the package 35 to the base structure 70A where the user 32 can pick up the package 35.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

Although the embodiments of disclosure have been described in detail for the purpose of illustration based on what is currently considered to be the most practical, it is to be understood that such detail is solely for that purpose and that the present disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed:

1. A system for protecting a user from potentially falling unmanned aerial vehicle (UAV) or package or both, the system comprising:
a base structure, wherein the base structure comprises a computer system configured to receive credentials of a user and a package retrieval system configured to receive the package from the user when the user drops-off the package or to provide the package to the user for the user to pick-up the package;
a roof structure attached to and extending from the base structure, the base structure being configured to support the roof structure, the roof structure being configured to support a weight of the UAV and package; and
a transport system configured and arranged to transport the package between the base structure and the roof structure
wherein the roof structure is configured to shield or protect a user from potentially falling UAV or package or both when the user is under the roof structure.

2. The system according to claim 1, wherein the transport system comprises a slide or a chute, a conveyor or an automated guided vehicle (AGV) system, or any combination thereof.

3. The system according to claim 1, wherein the roof structure comprises a platform configured and arranged to provide a landing or take-off area to the UAV.

4. The system according to claim 1, wherein the roof structure is a solid structure configured to protect the user from environmental elements including rain or sunlight.

5. The system according to claim 1, wherein the roof structure is a roof of an existing building and the base structure is provided at a base of the building.

6. The system according to claim 1, wherein the roof structure comprises a net or a grill to protect the user against potentially falling UAV and/or package.

7. The system according to claim 1, wherein the roof structure comprises a perforated portion and a solid portion, wherein the solid portion is configured to provide an area for landing or take-off of the UAV.

8. The system according to claim 1, wherein the roof structure comprises a deployable structure that is configured to deploy upon arrival of the UAV.

9. The system according to claim 8, wherein the deployable structure comprises a perforated structure.

10. The system according to claim 8, wherein the deployable structure is deployable by pivoting using a hinge system or deployed by projecting or sliding from the base structure.

11. The system according to claim 8, wherein the deployable structure comprises a perforated portion.

12. The system according to claim 1, wherein the base structure comprises a kiosk configured to receive the package from the user when the user drops-off the package or to provide the package to the user for the user to pick-up the package.

13. A system for protecting a user from potentially falling unmanned aerial vehicle (UAV) or package or both, the system comprising:
a base structure, wherein the base structure comprises a computer system configured to receive credentials of a user and a package retrieval system configured to receive the package from the user when the user drops-off the package or to provide the package to the user for the user to pick-up the package;
a roof structure attached to and extending from the base structure, the base structure being configured to support the roof structure, the roof structure being configured to support a weight of the UAV and package, and wherein the roof structure is configured to shield or protect a user from potentially falling UAV or package or both when the user is under the roof structure; and
a collision avoidance system on the UAV, the collision avoidance system being configured to communicate with sensors provided on the UAV and configured and arranged to detect people within a certain distance range of the base structure depending on a speed of the UAV so as to enable the UAV to perform avoidance manoeuvers to prevent collision with people or objects, or both.

14. The system according to claim 13, wherein the sensors are configured to detect people optically, via heat signature or detect movement of people.

15. The system according to claim 13, further comprising a transport system configured and arranged to transport the package between the base structure and the roof structure.

16. The system according to claim 13, further comprising defining an area around the detected people as a no-fly zone.

17. A method for protecting a user from potentially falling unmanned aerial vehicle (UAV) or package or both, the method comprising:
deploying a roof structure from a base structure, the roof structure being attached to and extending from the base structure;
landing a UAV carrying a package on the roof structure; and
supporting a weight of the UAV and package by the roof structure attached to the base structure,
wherein the roof structure is configured to shield or protect a user from potentially falling UAV or package or both when the user is under the roof structure.

18. The method according to claim 17, further comprising delivering the package to the user after landing the UAV on the roof structure.

19. The method according to claim 17, wherein the base structure comprises a computer system configured to receive credentials of a user and a package retrieval system configured to receive the package from the user when the user drops-off the package or to provide the package to the user for the user to pick-up the package
